(19) United States
(12) Patent Application Publication
(10) Pub. No.: US 2018/0111655 A1
(43) Pub. Date: Apr. 26, 2018

(54) INVERTED PENDULUM VEHICLE

(71) Applicant: HONDA MOTOR CO., LTD., Tokyo (JP)

(72) Inventors: Jun INADA, Wako-shi (JP); Tsutomu YOSHINO, Wako-shi (JP); Wataru YADA, Wako-shi (JP); Hiroshi IWAKAMI, Wako-shi (JP)

(21) Appl. No.: 15/726,850

(22) Filed: Oct. 6, 2017

(30) Foreign Application Priority Data
Oct. 20, 2016 (JP) 2016206272

(51) Int. Cl. B62K 11/00; B62K 1/00; B62M 13/00; B62M 7/10

(52) U.S. Cl. CPC B62K 11/007; B62M 7/10; B62M 13/00; B62K 1/00

(57) ABSTRACT

An inverted pendulum vehicle has a vehicle body frame, a main wheel combining a plurality of driven rollers arranged along a circle, a pair of drive disks rotatably supported by the vehicle body frame around a laterally extending rotational center line, a plurality of drive rollers arranged rotatably on each drive disk along a circumferential direction and configured to engage the driven rollers of the main wheel, a drive unit for individually driving the drive disks, a control unit for controlling the drive units under an inverted pendulum control, a tail wheel arm having a base end pivotally attached to a part of the vehicle body frame around a laterally extending pivot center line, a tail wheel rotatably supported by the tail wheel arm and a skid member attached to the tail wheel arm, the skid member including a pair of side walls slanting outward toward upper edges thereof.

### TECHNICAL FIELD

The present invention relates to an inverted pendulum vehicle, and in particular to an inverted pendulum vehicle having a main wheel operating under an inverted pendulum control and a tail wheel positioned behind the main wheel.

### BACKGROUND ART

JP2013-237327A and JP2014-234036A disclose an inverted pendulum vehicle comprising a vehicle body frame, a main wheel combining a plurality of driven rollers arranged along a circle such that the rotational center lines of the driven rollers are each directed along the tangential line of the circle, a pair of drive disks each carrying a plurality of drive rollers configured to engage the driven rollers of the main wheel, a pair of drive units including a pair of electric motors for individually driving the drive disks under an inverted pendulum control, a battery mounted on the vehicle body frame to supply electric power to the electric motors, and a saddle mounted on the vehicle body frame for seating a rider. To enable the vehicle to turn with a small turning radius, it is known to provide a tail wheel arm connected to a rear part of the vehicle at a base end thereof so as to be pivotable around a laterally extending rotational center line and a tail wheel rotatably attached to a free end of the tail wheel arm to engage the road surface.

In such an inverted pendulum vehicle, by individually controlling the rotational speeds of the drive disks, the vehicle is enabled to travel not only in the fore and aft direction, but also in an oblique forward direction, an oblique rearward direction and a lateral direction. Because the tail wheel engages the road surface, the vehicle is also enabled to undergo a yaw movement.

The main wheel is provided with a relatively large diameter, and is therefore able to ride over a step or other irregularities of the road surface to a certain extent, but the tail wheel is typically provided with a relatively small diameter, and is able to ride over a step to a lesser extent.

Therefore, the tail wheel typically determines the capability of the vehicle to ride over a step or other irregularities of the road surface. In particular, when the vehicle passes a step from an oblique direction, the tail wheel can be easily caught by the step in such a manner that a side of the tail wheel becomes engaged by the step. As a result, the vehicle may not be able to ride over the step even though the height of the step is not very significant.

### SUMMARY OF THE INVENTION

In view of such a problem of the prior art, a primary object of the present invention is to provide an inverted pendulum vehicle that can ride over a step or other irregularities even when crossing the step from an oblique direction or sideways.

To achieve such an object, the present invention provides an inverted pendulum vehicle, comprising: a vehicle body frame (12); a main wheel (40) combining a plurality of driven rollers (44) arranged along a circle such that rotational center lines of the driven rollers are each directed along a tangential line of the circle; a pair of drive disks (50) rotatably supported by the vehicle body frame around a laterally extending rotational center line; a plurality of drive rollers (52) arranged rotatably on each drive disk along a circumferential direction and configured to engage the driven rollers of the main wheel; a drive unit (72, 86) for individually driving the drive disks; a control unit (102) for controlling the drive units under an inverted pendulum control; a tail wheel arm (110) having a base end pivotally attached to a part of the vehicle body frame around a laterally extending pivot center line; a tail wheel (126) rotatably supported by a free end of the tail wheel arm; and a skid member (130; 140) attached to the free end of the tail wheel arm, the skid member including a pair of side walls slanting outward toward upper edges thereof.

When the vehicle travels across a step at an angle (in a direction non-orthogonal to the step), a part of the skid member (typically one of the side walls, and possibly the front wall) abuts the step so that a force component that lifts the tail wheel arm is applied to the skid member. As a result, the tail wheel arm is caused to pivot upward by the guiding action of the skid member so that the tail wheel is enabled to smoothly ride over the step. Thus, when the vehicle travels across a step at an angle, the tail wheel of the vehicle is not hindered by the step even when the outer diameter of the tail wheel is considerably smaller than that of the main wheel. Preferably, the tail wheel is rotatably supported by the free end of the tail wheel arm via a bracket, and the skid member is attached to the free end of the tail wheel arm via the bracket.

For this to be accomplished in a favorable manner, each side wall may include a portion positioned ahead of a rotational center line of the tail wheel.

According to a preferred embodiment of the present invention, the skid member further includes a front wall (130C; 140C) slanting outward toward an upper edge thereof.

When the vehicle travels across a step from a generally orthogonal direction, the front wall of the skid member abuts the step so that a force component that lifts the tail wheel arm is applied to the skid member. As a result, the tail wheel arm is caused to pivot upward by the guiding action of the skid member so that the tail wheel is enabled to smoothly ride over the step. Thus, when the vehicle travels across a step at a substantially right angle, the tail wheel of the vehicle is not hindered by the step even when the outer diameter of the tail wheel is considerably smaller than that of the main wheel. To further enhance this effect, the front wall may be provided with a convex arcuate outer surface.

According to another preferred embodiment of the present invention, the skid member (140) consists of a frame member surrounding the tail wheel from four sides.

Thereby, the skid member can be supported by the free end of the tail wheel arm or the bracket attached thereto in a stable manner.

Preferably, the skid member further includes a bottom wall (140A) extending substantially horizontally, and the bottom wall is formed with an opening (140E) through which a lower part of the tail wheel passes. Thereby, the tail wheel and the associated part such as the bracket can be favorably protected from damages or prevented from damaging the floor surface.

Alternatively or additionally, the skid member may further include a rear wall (140D) slanting outward toward an upper edge thereof.

When the vehicle travels rearward across a step from a generally orthogonal direction, the rear wall of the skid member abuts the step so that a force component that lifts the tail wheel arm is applied to the skid member. As a result, the tail wheel arm is caused to pivot upward by the guiding action of the skid member so that the tail wheel is enabled to smoothly ride over the step. Thus, when the vehicle travels rearward across a step at a substantially right angle, the tail wheel of the vehicle is not hindered by the step even when the outer diameter of the tail wheel is considerably smaller than that of the main wheel. To further enhance this effect, the rear wall may be provided with a convex arcuate outer surface. For this to be accomplished in a stable manner, each side wall may include a portion positioned ahead of a rotational center line of the tail wheel and a portion positioned behind the rotational center line of the tail wheel.

The skid member may be made of an electrically insulating material.

Thereby, the skid member functions also as an electrically insulating cover for the part of the tail wheel arm or the bracket supporting the tail wheel.

### BRIEF DESCRIPTION OF THE DRAWINGS

FIG. 1 is a side view of a first embodiment of an inverted pendulum vehicle according to the present invention;

FIG. 2 is a front view of the inverted pendulum vehicle;

FIG. 3 is a sectional view taken along line of FIG. 1;

FIG. 4 is a fragmentary sectional side view of a tail wheel and a skid member of the inverted pendulum vehicle;

FIG. 5 is an enlarged rear view of a tail wheel arm and associated components;

FIG. 6 is an enlarged perspective view of the skid member;

FIG. 7 is a simplified perspective view of a skid member of another embodiment;

FIG. 8 is a view similar to FIG. 7 showing a skid member of yet another embodiment;

FIG. 9 is a view similar to FIG. 1 showing a second embodiment of an inverted pendulum vehicle according to the present invention;

FIG. 10 is an enlarged perspective view of the skid member used in the inverted pendulum vehicle of the second embodiment of the present invention; and

FIG. 11 is a view similar to FIG. 10 showing a skid member of an alternate embodiment.

### DESCRIPTION OF THE PREFERRED EMBODIMENT(S)

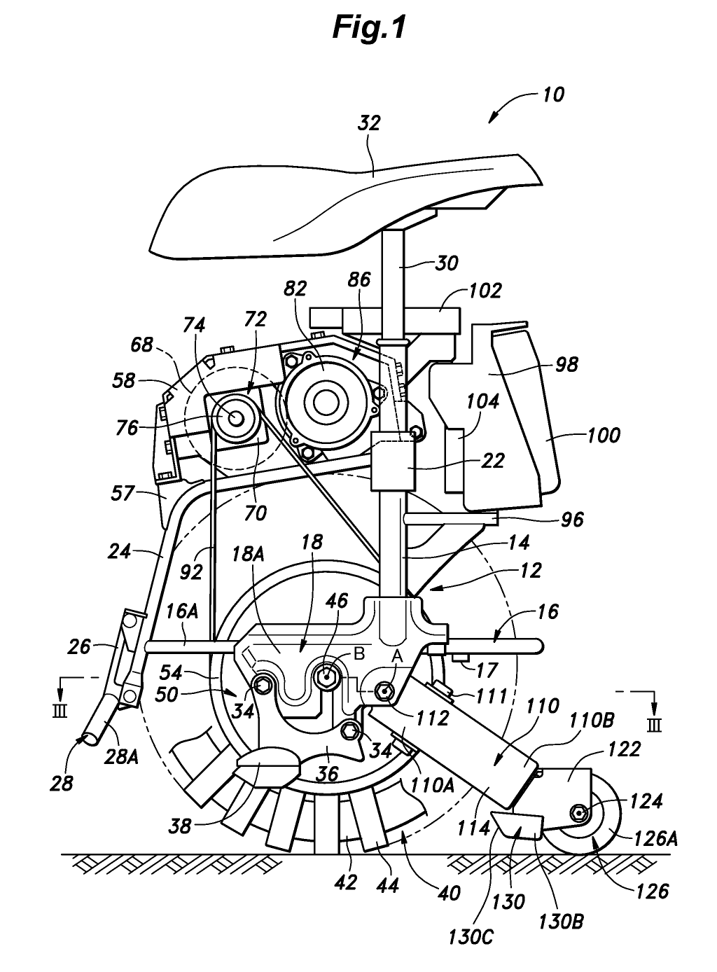

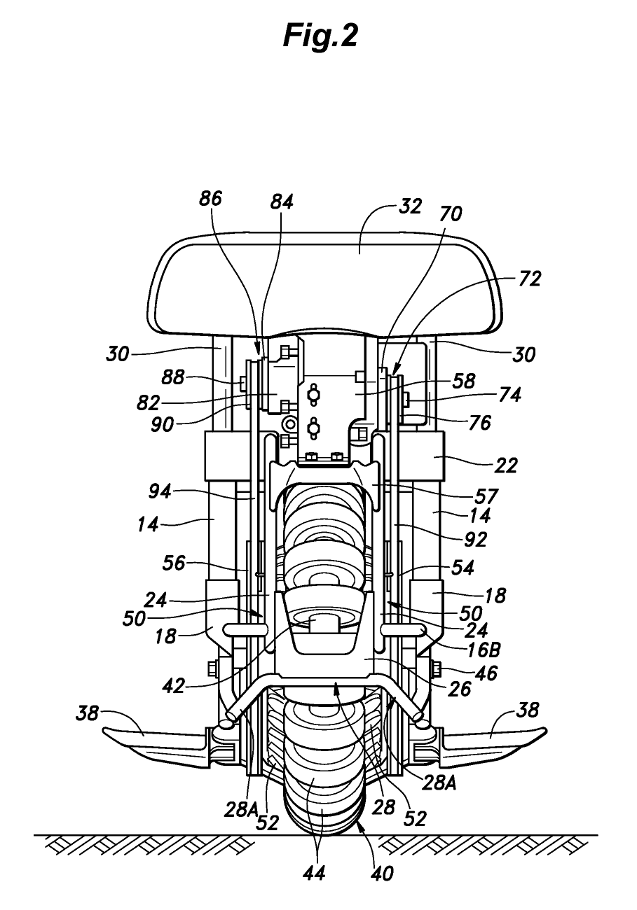

A first embodiment of an inverted pendulum vehicle according to the present invention is described in the following with reference to FIGS. 1 to 6. The directions mentioned in the following description are based on the viewpoint of a rider seated on the inverted pendulum vehicle.

As shown in FIGS. 1 to 6, the inverted pendulum vehicle 10 includes a vehicle body frame 12 made of pipe members. The vehicle body frame 12 includes a pair of main posts 14 located on either side of the vehicle, a lower pipe member 16 including a pair of side member sections 16A extending along either side of the vehicle and joined to the lower ends of the respective main posts 14 at intermediate points thereof, and a rear cross member section 16B extending between rear ends of the two side member sections 16A, a pair of lower plates 18 extending downward from the respective side member sections 16A of the lower pipe member 16, a main cross member 22 extending between intermediate points of the main posts 14, and a pair of side pipe members 24 extending along either side of a main wheel 40 and having rear ends connected to the main cross member 22 and front ends bent downward to be connected to the front ends of the respective side member sections 16A of the lower pipe member 16. The lower plates 18 each consist of an outer panel 18A and an inner panel 18B, and are positioned on either side of the main wheel 40 so as not to interfere with the main wheel 40.

A saddle 32 is provided with a pair of saddle posts 30 depending therefrom in a laterally spaced apart relationship, and these saddle posts 30 are slidably inserted in the upper ends of the respective main posts 14 in an adjustable manner by means of an adjustment mechanism not shown in the drawings. A foot rest bracket 36 is fixedly attached to each lower plate 18 via threaded bolts 34, and is fitted with a foot rest 38 for placing the corresponding leg of the rider.

A disk support shaft 46 is passed laterally through the hollow center of the main wheel 40, and is fixedly supported by the lower plates 18 at two ends thereof.

The disk support shaft 46 rotatably supports a pair of drive disks 50 in an individually rotatable manner around a common rotational center line.

The main wheel 40 is provided with an omni-wheel configuration, and includes a metallic annular member 42 having a laterally extending center line, and a plurality of driven rollers (free rollers) 44 rotatably supported by the annular member 42. Each driven roller 44 is provided with an outer peripheral part made of rubber material, and is rotatable around the tangential line of the annular member 42 at which the particular driven roller 44 is supported via a ball bearing 43.

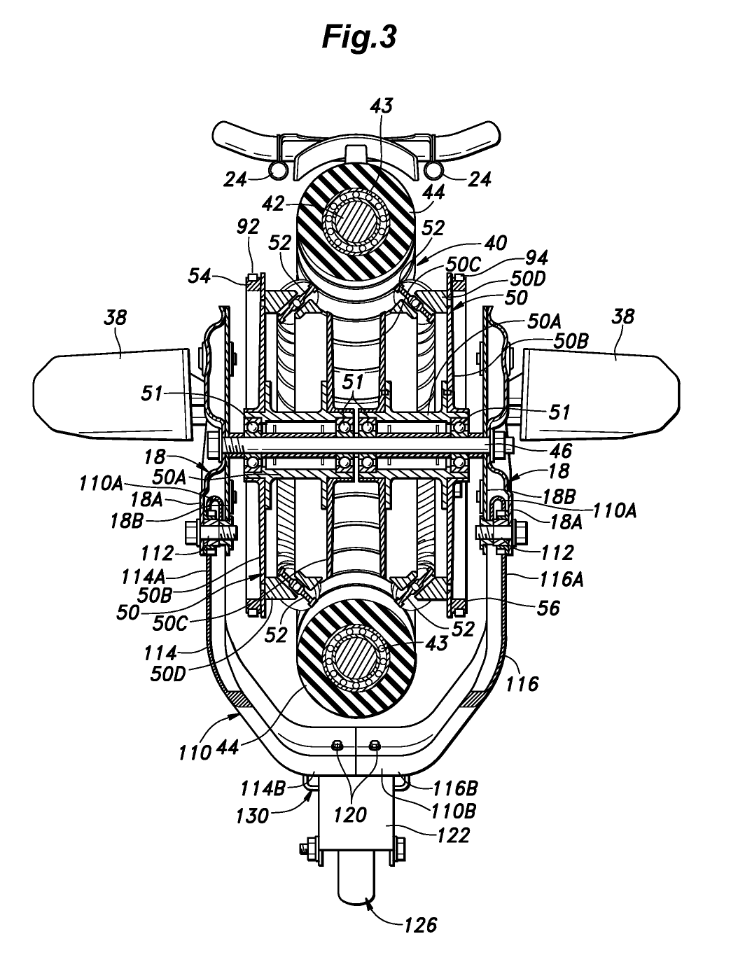

As shown in FIG. 3, each drive disk 50 is positioned on a corresponding side of the main wheel 40, and each includes a hub member 50A supported by the disk support shaft 46 via a pair of roller bearings 51, a circular outer plate 50B attached to an outer end of the hub member 50A, a circular inner plate 50C attached to an inner end of the hub member 50A and a roller support member 50D fixedly secured between the outer plate 50B and the inner plate 50C along the outer periphery of the outer plate 50B and the inner plate 50C, all in a coaxial relationship.

A plurality of metallic drive rollers (free rollers) 52 are supported on a peripheral part of each roller support member 50D along a circumferential direction at a regular interval in an individually rotatable manner. The two drive disks 50 along with the drive rollers 52 are arranged in a symmetric manner or as a mirror image of each other, and the rotational center lines of the drive rollers 52 are in a skewed relationship to the rotational center line of the drive disks 50.

The drive rollers 52 of each drive disk 50 are pressed against the outer circumferential surfaces of the driven rollers 44 of the main wheel 40 such that the main wheel 40 is rotatably supported around the rotational center line thereof which is substantially coaxial to those of the drive disks 50 (but this does not limit the scope of the present invention). Thus, the main wheel 40 is allowed to rotate around the rotational center line thereof without requiring a pivot shaft.

A driven pulley 54, 56 for a cogged belt is coaxially attached to the outer periphery of each drive disk 50. Any other types of belts and chain links may also be used instead of the cogged belt.

The two bent intermediate parts of the side pipe members 24 are connected to each other by a front cross member 57, and a motor mount member 58 is fixedly attached to the front cross member 57. A left drive unit 72 and a right drive unit 86 are mounted on the side pipe members 24 via the motor mount member 58 one behind the other in a laterally inverted relationship.

The left drive unit 72 includes an electric motor 68 and a speed reduction unit 70. An output shaft 74 of the speed reduction unit 70 is fitted with a drive pulley 76. An endless cogged belt 92 is passed around the left drive pulley 76 and the left driven pulley 54. The right drive unit 86 includes an electric motor 82 and a speed reduction unit 84. An output shaft 88 of the speed reduction unit 84 is fitted with a drive pulley 90. An endless cogged belt 94 is passed around the right drive pulley 90 and the right driven pulley 54.

A rear pipe member 96 extends rearward from rear ends of intermediate points of the main posts 14, and includes a pair of fore and aft pieces extending rearward from the rear ends of the intermediate points of the respective main posts 14, and a cross piece extending between the rear ends of the fore and aft pieces. A battery box 98 is mounted on the upper side of the rear pipe member 96 to detachably receive a battery 100 therein. The battery 100 and the battery box 98 are positioned behind the two drive units 72 and 86, and vertically between the main wheel 40 and the saddle 32. The battery 100 supplies electric power to the electric motors 68 and 82 and various onboard units such as a main wheel PDU 102.

The main wheel PDU 102 is supported by upper parts of the main posts 14 so as to be positioned immediately under the saddle 32. The main wheel PDU 102 includes a computer for controlling the electric motors 68 and 82 in such a manner that the inverted pendulum control and the propulsion control of the vehicle may be performed according to various sensor signals such as an output signal from a gyro sensor 104 attached to the battery box 98.

When the gravitational center of the vehicle 10 including the rider is at the neutral position (or on the vertical line passing through the rotational center line of the main wheel 40), the electric motors 68 and 82 are driven in such a manner that the vehicle body frame 12 is maintained in an upright posture as shown in FIG. 1.

When the gravitational center of the vehicle 10 including the rider is shifted forward, for instance by the rider leaning forward, the main wheel PDU 102 commands the electric motors 68 and 82 to rotate in the normal direction at a same speed. As a result, the main wheel 40 rotates in the normal direction around the rotational center line thereof, and the vehicle 10 travels straight forward. At this time, as there is no speed difference between the two drive disks 50, the drive rollers 52 of the drive disks 50 and the driven rollers 44 of the main wheel 40 do not rotate around the respective rotational center lines so that no lateral movement takes place.

When the gravitational center of the vehicle 10 including the rider is shifted rearward, for instance by the rider leaning rearward, the main wheel PDU 102 commands the electric motors 68 and 82 to rotate in the reverse direction at a same speed. As a result, the main wheel 40 rotates in the reverse direction around the rotational center line thereof, and the vehicle 10 travels straight rearward. At this time, as there is no speed difference between the two drive disks 50, the drive rollers 52 of the drive disks 50 and the driven rollers 44 of the main wheel 40 do not rotate around the respective rotational center lines so that no lateral movement takes place.

When the gravitational center of the vehicle 10 including the rider is shifted sideways, for instance by the rider leaning sideways, the main wheel PDU 102 commands the electric motors 68 and 82 to rotate in different directions and/or at different speeds. This causes a difference between the rotational speeds of the two drive disks 50. As a result, the driven rollers 44 of the main wheel 40 are driven by the drive rollers 52 of the drive disks 50, and rotate around the rotational center lines of the driven rollers 44.

The rotational speed of the driven rollers 44 depend on the difference between the rotational speeds of the drive disks 50. For instance, when the two drive disks 50 are rotated at a same speed in different directions, the main wheel 40 does not rotate around the rotational center line thereof, and only the driven rollers 44 rotate around the respective rotational center lines. As a result, the vehicle 10 travels sideways. By rotating the drive disks 50 in a same direction or in different directions at different speeds, the main wheel 40 rotates around the rotational center line thereof, and the driven rollers 44 rotate around the respective rotational center lines at the same time so that the vehicle 10 travels in an oblique direction.

The front ends of the side pipe members 24 are connected to each other by a front plate 26 which carries a stand 28. The stand 28 includes a pair of legs 28A extending downward from either side of the stand 28. When the inverted pendulum control is terminated, and the vehicle body frame 12 is tilted forward, the free ends of the legs abut the ground surface so that the vehicle body frame 12 can be retained in the forwardly tilted parked position in a stable manner. When the vehicle body frame 12 is in the upright posture under the inverted pendulum control as shown in FIG. 1, as the legs 28A are substantially spaced apart from the ground surface, the stand 28 does not interfere with the movement of the inverted pendulum vehicle 10.

A tail wheel arm 110 is attached to the left and right lower plates 18. The tail wheel arm 110 comprises a left member 114 and a right member 116 which are pivotally attached to the respective lower plates 18 at base ends thereof via individual arm support shafts 112 extending laterally and coaxially attached to the respective lower plates. Each of the left member 114 and the right member 116 consists of a plate member having a major plane facing laterally and elongated in the fore and aft direction. The pivoted base end of the tail wheel arm 110 is denoted with numeral 110A in FIG. 1.

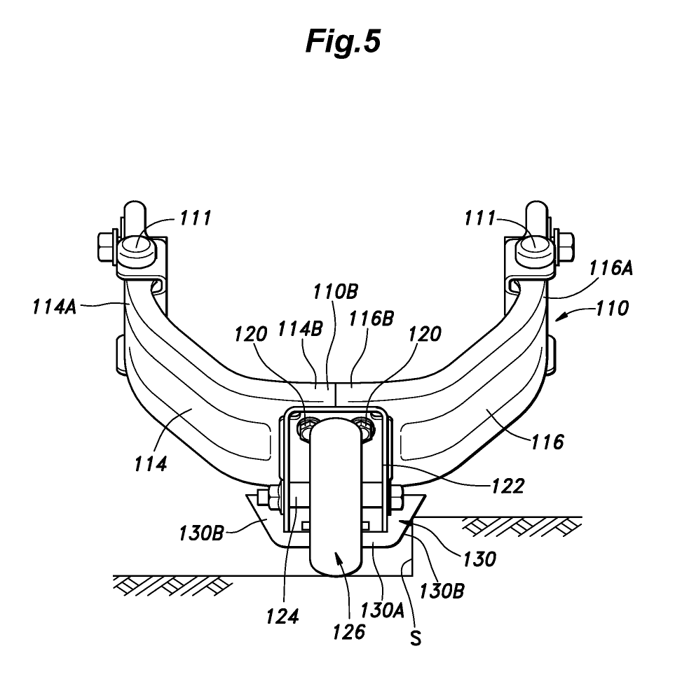

As shown in FIG. 5, the left member 114 includes a front end part 114A extending rearward from the base end 110A, and a rear end part 114B bent in the inboard direction. Similarly, the right member 116 includes a front end part 116A extending rearward from the base end 110A, and a rear end part 116B bent in the inboard direction. The inboard ends of the two rear end parts 114B and 116B are connected to each other via a bracket 122 fastened to the two rear end parts 114B and 116B with threaded bolts 120. Therefore, the tail wheel arm 110 can be pivotally attached to the lower plates 18 with an adequate mechanical strength without interfering with the main wheel 40.

A stopper 111 is attached to the upper edge of each of the front end parts 114A and 116A of the left member 114 and the right member 116, and is positioned to abut a stopper 17 attached to a corresponding part of the lower pipe member 16 when the vehicle body frame 12 is tilted backward to a maximum extent.

As shown in FIGS. 3 to 5, the bracket 122 is provided with a pair of side walls, an upper wall extending between the upper edges of the side walls, and a lower wall having a relatively small fore and aft dimension extending between the lower edges of the side walls. A pivot shaft 124 extending between the side walls rotatably supports a tail wheel 126 provided with a rubber tire 126A. The tail wheel 126 contacts the ground surface at some distance behind the ground contact point of the main wheel 40. The tail wheel 126 assists a yaw movement of the vehicle 10 when the driven rollers 44 of the main wheel 40 are rotated around the corresponding tangential lines of the main wheel 40. The pivot center A in the base end of the tail wheel arm 110 is defined by the center of the arm support shaft 112, and is located behind the center B of the disk support shaft 46 (FIG. 1).

For the tail wheel 126 to be most effective in producing a yaw movement of the vehicle 10, the tail wheel 126 should be located right behind the main wheel 40. In other words, the main wheel 40 and the tail wheel 126 should be located on a hypothetical plane orthogonal to the lateral direction and dividing the vehicle 10 into two equal parts. Also, the length of the tail wheel arm 110 is determined such that the tail wheel 126 does not interfere with the main wheel 40 without regard to the position of the vehicle 10 or without regard if the vehicle 10 is in the upright condition, in the forwardly tilted position or in the rearwardly tilted position.

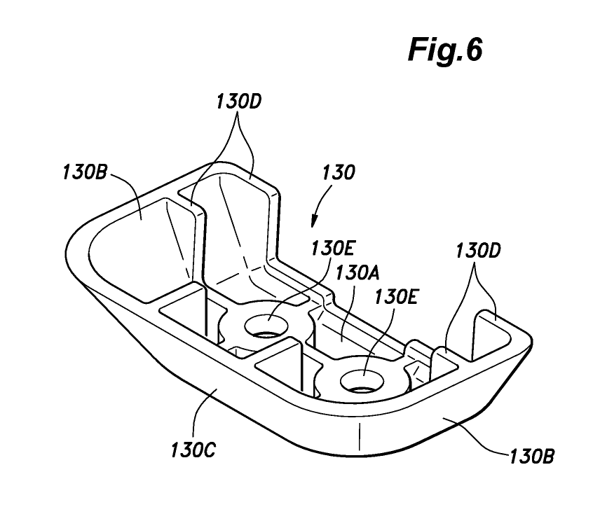

A skid member 130 is attached to the lower wall of the bracket 122 in a detachable manner by using a pair of threaded bolts 132. As shown in FIG. 6, the skid member 130 is made of electrically insulting material such as plastic material, and includes a rectangular and planar bottom wall 130A, a pair of planar side walls 130B extending upright from either side edge of the bottom wall 130A, a planar front wall 130C extending upright from the front edge of the bottom wall 130A and connected between the front edges of the side walls 130B, and ribs 130D extending from the inner surfaces of the walls 130A to 130C for reinforcement. The bottom wall 130A is formed with a pair of holes 130E for passing the threaded bolts 132.

The side walls 130B slant outward toward the upper edges thereof or away from the tail wheel 126, and the front wall 130C also slant forward toward the upper edge thereof or away from the tail wheel 126.

When the vehicle 10 travels across a step S at an angle (in a direction non-orthogonal to the step S) as shown in FIG. 5, a part of the skid member 130 (typically one of the side walls 130B, and possibly the front wall 140C) abuts the step S so that a force component that lifts the tail wheel arm 110 is applied to the skid member 130 owing to the slanted outer surface of the side walls 130B (or the front wall 130C). As a result, the tail wheel arm 110 is caused to pivot upward by the guiding action of the skid member 130 so that the tail wheel 126 is enabled to smoothly ride over the step S.

Thus, when the vehicle 10 travels across a step S at an angle, the tail wheel 126 of the vehicle 10 is not hindered by the step S even when the outer diameter of the tail wheel 126 is considerably smaller than that of the main wheel 40.

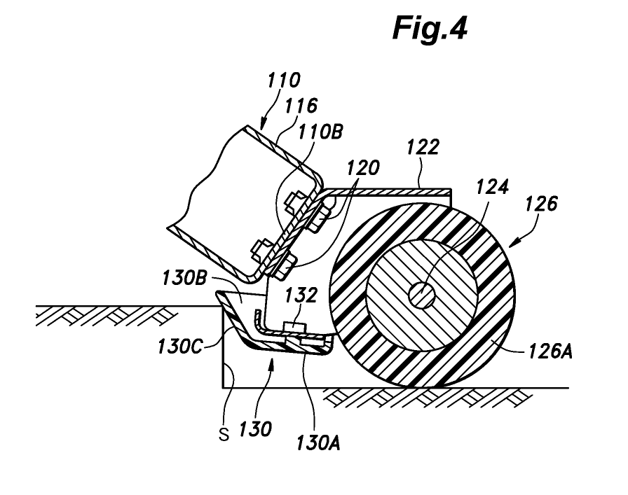

Similarly, when the vehicle 10 travels across a step S from an orthogonal direction, the front wall 140C of the skid member 130 abuts the step S as shown in FIG. 4 so that a force component that lifts the tail wheel arm 110 is applied to the skid member 130. As a result, the tail wheel arm 110 is caused to pivot upward by the guiding action of the skid member 130 so that the tail wheel 126 is enabled to smoothly ride over the step S.

Thus, when the vehicle 10 travels across a step S at a right angle, the tail wheel 126 of the vehicle 10 is not hindered by the step S even when the outer diameter of the tail wheel 126 is considerably smaller than that of the main wheel 40.

Because the skid member 130 is made of electrically insulating material, the skid member 130 serves also as an insulating cover for the bracket 122 so that even when the bracket 122 is made of metallic material, annoying electrostatic sparks are prevented from being produced between the bracket 122 an the road surface which is typically electro-conductive.

Furthermore, the skid member 130 serves as a protector for the bracket 122 and the tail wheel arm 110 whereby the bracket 122 and the tail wheel arm 110 are prevented from directly touching the floor surface and thereby damaging the floor surface or being damaged by the floor surface. Since the skid member 130 is attached to the bracket 122 by the threaded bolts 132 in a detachable manner, when the skid member 130 has worn our or has been damaged, the skid member 130 can be readily replaced with a new one.

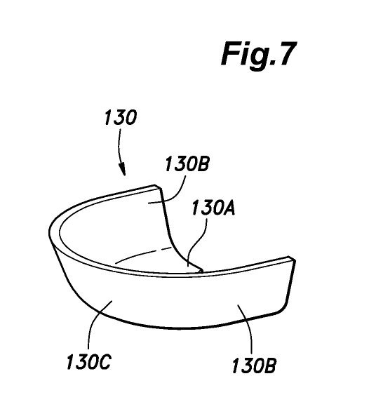

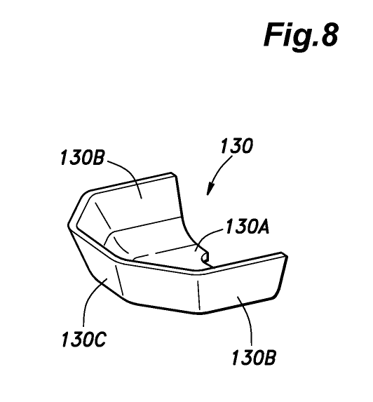

The skid member 130 is not necessarily required to be rectangular in plan view, but may also be provided with an arcuate front wall 130C so that the skid member 130 is arch-shaped in plan view as shown in FIG. 7. In this case also, the surrounding wall of the skid member 130 may be slanted outward toward the upper edge thereof. The front wall 130C may also consist of a plurality of planar segments that jointly define an arcuate profile in plan view as shown in FIG. 8.

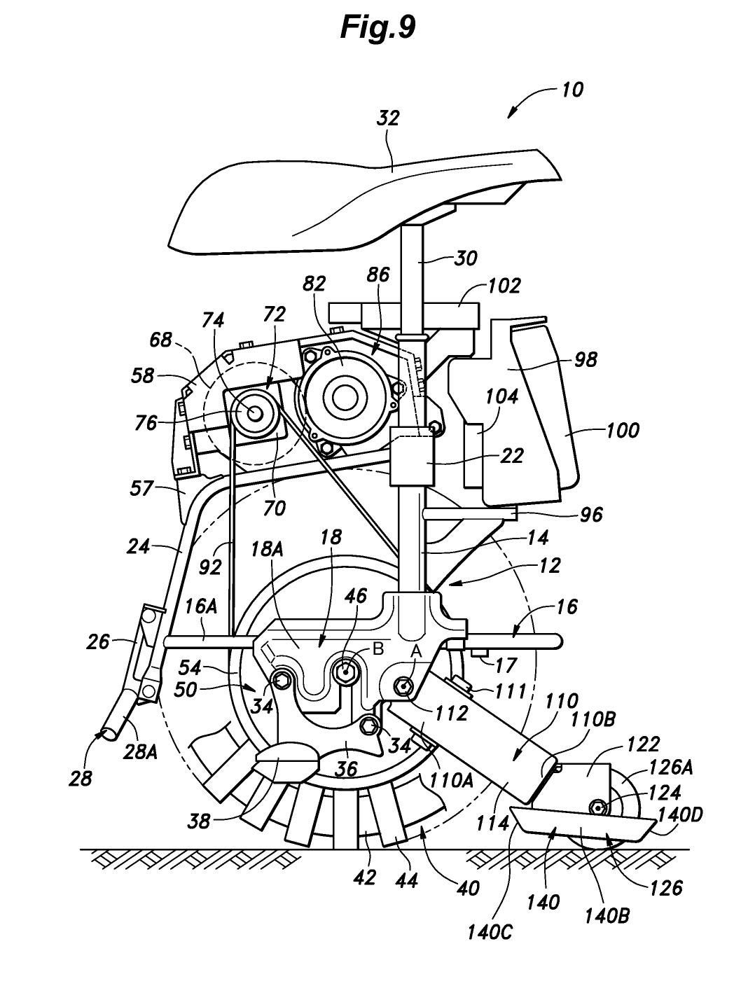

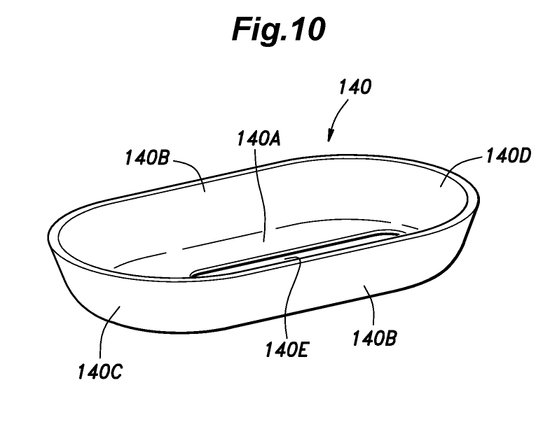

A second embodiment of the inverted pendulum vehicle is described in the following with reference to FIGS. 9 and 10. In FIG. 9, the parts corresponding to those shown in FIG. 1 are denoted with like numerals, and may be omitted in the following description.

In this embodiment also, the skid member 140 is attached to the bottom end of the bracket 122. The skid member 140 is made of electrically insulating material such as plastic material, and includes a planar rectangular bottom wall 140A elongated in the fore and aft direction, a pair of planar side walls 140B extending upright from either side edge of the bottom wall 140A, an arcuate front wall 140C extending from the front edge of the bottom wall 140A and connected between the front edges of the side walls 140B, and an arcuate rear wall 140D extending from the rear edge of the bottom wall 140A and connected between the rear edges of the side walls 140B. Thus, the skid member 140 is shaped like a bath tub.

Each side wall 140B includes a part extending in the fore and aft direction along a middle part of the tail wheel 126 containing the rotational center line thereof, and slants outward or away from the tail wheel 126 toward the upper edge of the side wall 140B. The arcuate front wall 140C has a convex side facing forward, and slants outward or away from the tail wheel 126 toward the upper edge of the front wall 140C. The arcuate rear wall 140D has a convex side facing rearward, and slants outward or away from the tail wheel 126 toward the upper edge of the rear wall 140D. The bottom wall 140A is provided with a slot 140E or an opening of any other shape through which a lower part of the tail wheel 126 passes. In this way, the skid member 140 is formed as a frame member surrounding the tail wheel 126 from four sides or from the front, from the rear and from the both sides.

When the vehicle 10 travels across a step S at an angle (in a direction non-orthogonal to the step S), a part of the skid member 140 (typically one of the side walls 140B, and possibly the front wall 140C) abuts the step S so that a force component that lifts the tail wheel arm 110 is applied to the skid member 140. As a result, the tail wheel arm 110 is caused to pivot upward by the guiding action of the skid member 140 so that the tail wheel 126 is enabled to smoothly ride over the step S.

Thus, when the vehicle 10 travels across a step S at an angle, the tail wheel 126 of the vehicle 10 is not hindered by the step S even when the outer diameter of the tail wheel 126 is considerably smaller than that of the main wheel 40.

Similarly, when the vehicle 10 travels across a step S from an orthogonal direction, the front wall 140C of the skid member 140 abuts the step S so that a force component that lifts the tail wheel arm 110 is applied to the skid member 140. As a result, the tail wheel arm 110 is caused to pivot upward by the guiding action of the skid member 140 so that the tail wheel 126 is enabled to smoothly ride over the step S.

Thus, when the vehicle 10 travels across a step S at a right angle, the tail wheel 126 of the vehicle 10 is not hindered by the step S even when the outer diameter of the tail wheel 126 is considerably smaller than that of the main wheel 40.

When the vehicle 10 travels rearward across a step S, the rear wall 140D of the skid member 140 abuts the step S so that a force component that lifts the tail wheel arm 110 is applied to the skid member 140. As a result, the tail wheel arm 110 is caused to pivot upward by the guiding action of the skid member 140 so that the tail wheel 126 is enabled to smoothly ride over the step S.

Thus, when the vehicle 10 travels rearward across a step S at a right angle, the tail wheel 126 of the vehicle 10 is not hindered by the step S even when the outer diameter of the tail wheel 126 is considerably smaller than that of the main wheel 40.

Thus, the vehicle 10 is enabled to ride over a step S in an orthogonal forward movement, an orthogonal rearward movement, an oblique forward movement, an oblique rearward movement or a lateral movement without the tail wheel 126 being hindered by the step S.

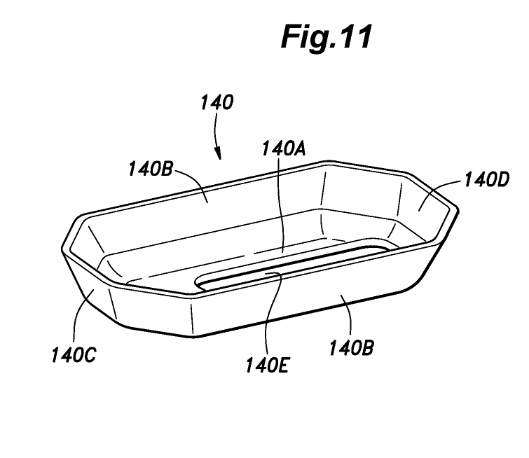

The skid member 140 is not necessarily required to be rectangular or elliptic in plan view, but the front wall 140C may also consist of a plurality of planar segments that jointly define an arcuate profile in plan view as shown in FIG. 11.

Although the present invention has been described in terms of preferred embodiments thereof, it is obvious to a person skilled in the art that various alterations and modifications are possible without departing from the spirit of the present invention.

For instance, the tail wheel arm 110 and the bracket 122 may be formed as an integral member such that the tail wheel arm 110 is integrally formed with the bracket 122. In such a case, the bracket 122 may be attached to the free end of the tail wheel arm 110 or an adjoining part thereof.

The vehicle body frame 12 may be modified from that of the illustrated embodiment without departing from the spirit of the present invention. Also, the outer diameter of the drive disks 50 may be substantially smaller than the inner diameter of the main wheel 40 so that the rotational center of the drive disks 50 is significantly offset from the rotational center of the main wheel 40.

In addition, various elements shown in the above described embodiment are not entirely essential for the present invention, and can be appropriately omitted without departing from the spirit of the present invention.

1. An inverted pendulum vehicle, comprising:
a vehicle body frame;
a main wheel combining a plurality of driven rollers arranged along a circle such that rotational center lines of the driven rollers are each directed along a tangential line of the circle;
a pair of drive disks rotatably supported by the vehicle body frame around a laterally extending rotational center line;
a plurality of drive rollers arranged rotatably on each drive disk along a circumferential direction and configured to engage the driven rollers of the main wheel;
a drive unit for individually driving the drive disks;
a control unit for controlling the drive units under an inverted pendulum control;
a tail wheel arm having a base end pivotally attached to a part of the vehicle body frame around a laterally extending pivot center line;
a tail wheel rotatably supported by a free end of the tail wheel arm; and
a skid member attached to the free end of the tail wheel arm, the skid member including a pair of side walls slanting outward toward upper edges thereof.

2. The inverted pendulum vehicle according to claim 1, wherein the tail wheel is rotatably supported by the free end of the tail wheel arm via a bracket, and the skid member is attached to the free end of the tail wheel arm via the bracket.

3. The inverted pendulum vehicle according to claim 1, wherein each side wall includes a portion positioned ahead of a rotational center line of the tail wheel.

4. The inverted pendulum vehicle according to claim 1, wherein the skid member further includes a front wall slanting outward toward an upper edge thereof.

5. The inverted pendulum vehicle according to claim 4, wherein the front wall is provided with a convex arcuate outer surface.

6. The inverted pendulum vehicle according to claim 1, wherein the skid member consists of a frame member surrounding the tail wheel from four sides.

7. The inverted pendulum vehicle according to claim 6, wherein each side wall includes a portion positioned ahead of a rotational center line of the tail wheel and a portion positioned behind the rotational center line of the tail wheel.

8. The inverted pendulum vehicle according to claim 7, wherein the skid member further includes a bottom wall extending substantially horizontally.

9. The inverted pendulum vehicle according to claim 8, wherein the bottom wall is formed with an opening through which a lower part of the tail wheel passes.

10. The inverted pendulum vehicle according to claim 8, wherein the skid member further includes a rear wall slanting outward toward an upper edge thereof.

11. The inverted pendulum vehicle according to claim 1, wherein the skid member is made of an electrically insulating material.
